(19) United States
(12) Patent Application Publication
(10) Pub. No.: US 2003/0183980 A1
(43) Pub. Date: Oct. 2, 2003

(54) Method and device for production of a reinforced plastic component and said component

(76) Inventor: Friedhelm Beckmann, Hiddenhausen (DE)

Correspondence Address: JORDAN AND HAMBURG LLP, 122 EAST 42ND STREET, SUITE 4000, NEW YORK, NY, 10168, US

(21) Appl. No.: 10/332,086

(22) PCT Filed: Jul. 28, 2001
(86) PCT No.: PCT/DE01/02897

(30) Foreign Application Priority Data
Aug. 3, 2000 (DE) 10038553.2

(51) Int. Cl. B29C 39/00

(52) U.S. Cl. 264/239

(57) ABSTRACT

The invention relates to a method for the production of a reinforced plastic component, in particular, by injection moulding, extruding or extrusion blowing, whereby a thermoplastic base material is prepared as a melt and a reinforcing material obtained from plant material is introduced. Said reinforcing material is in the form of comminuted shavings which may be poured and dispensed, in particular, derived from annual plants and/or similarly comminuted woody components from china reed. The above material is added to the melt of the base material and mixed to give a homogenous material, whereby the reinforcing material essentially contains no fractions of fibrous material which effect the ability thereof to be poured or dispensed.

The invention relates to a method for producing a reinforced plastic component, particularly by injection molding, extrusion, or extrusion blowing, in which a thermoplastic base material is prepared as a melt and a reinforcing material, obtained from plant materials, is introduced. The invention furthermore relates to a device for producing a reinforced plastic component, particularly for implementing the inventive method, having a feed station for feeding in thermoplastic material that is to be treated, and a plasticizing and mixing segment for plasticizing and homogenizing the base material. Furthermore, the invention relates to a reinforced plastic component, particularly a component produced by injection molding, extrusion, or extrusion blowing, having a thermoplastic base material and a reinforcing material obtained from plant materials.

In the production of components made from a thermoplastic base material, the usual processing methods for thermoplastic materials, such as injection molding, extrusion blowing, profile extrusion, etc., are generally employed. Such components are used in many different kinds of industries, for example the automotive industry, the construction industry, and the electrical industry. In most cases, components having a high degree of component rigidity are required. In such cases, fiberglass can be added as reinforcing material, in the form of short glass fibers having a length of 1 mm to 4 mm, or in the form of long glass fibers having a length of 10 mm to 12 mm. However, since fiberglass has disadvantageous recycling properties and results in pollution-causing residues in the case of thermal recycling, attempts have been made to replace fiberglass with natural fibers, for example of flax, hemp, jute, sisal, kenaf, ramie, or nettle plants. Since the length of the fibers, which are to be used with the methods mentioned, is limited, the homogeneous introduction of the fibers into a plastic melt is a major problem.

One possible procedure is to produce a card sliver first by parallelizing the fibers and, subsequently, to spin this into a yarn, by twisting. The yarn is then impregnated with a plastic melt in an extrusion system, and cut to the desired length in a subsequent cutting unit. This method is complicated and expensive.

It is not possible to introduce natural fibers into a melt directly, since the natural fibers become felted or tangled and cannot be mixed into a melt homogeneously.

It is an object of the invention is to provide a method and a device, with which it is possible to mix a reinforcing material obtained from plant materials homogeneously into a plasticized base material in the simplest manner possible.

With regard to the method, this objective is accomplished in that comminuted shives, particularly of annual plants, and/or similarly comminuted woody components of China reed (i.e. in a dumpable or pourable form) are supplied in a dumpable and pourable form to the melt of the base material as a reinforcing material, and are mixed homogeneously into it, the reinforcing material not containing any portions of (residual) fiber material, which significantly impair the dumpability or pourability.

The shives or the woody components of the China reed can be comminuted either in advance of or directly in conjunction with the preparation of the thermoplastic material and the production of components.

Preferably, shives of green starting material are used. Green starting material is understood to be plant material, such as straw of flax or hemp, which remains outdoors or on the field several days, such as five to eight days, after having been harvested, so that the green shives retain almost their original strength, in contrast to so-called land retted material, which remains on the field for approximately five to eight weeks.

Preferably, the length of the shives is 0.5 mm to 10 mm, preferably 0.5 mm to 5 mm and especially 0.5 mm to 3 mm.

Preferably, shives of flax and/or hemp and/or kenaf are used.

In an embodiment of the invention, additional reinforcing materials, such as glass fibers and/or natural fibers, are used (particularly in a separate step of the method).

Compatibility-producing agents may be used, particularly in an amount of between 0.5 and 3%, for example when polypropylene is the base material.

A thermoplastic plastic and/or a biological material, such as lignin or PHP, may be used as the thermoplastic base material.

Shives have a porous, sponge-like structure, which does not withstand the high pressure, which occurs during extrusion, for example, and results in compacting and an undesirable partial loss of the weight advantage, particularly in conjunction with the higher temperatures, which are unavoidable in the processing of thermoplastic materials. Therefore, in a further embodiment of the invention, before the reinforcing material (in the form of comminuted shives or comminuted woody components of China reed) is introduced into a thermoplastic base material, a stabilizing material may be introduced into the pores of the reinforcing material and/or the reinforcing material is mantled with the stabilizing material, so that the latter has a greater resistance to compression.

The pores and cavities of the reinforcing material may be filled with the stabilizing material to the greatest possible extent, for example, by dipping the material into a correspondingly liquid stabilizing material. Alternatively, the reinforcing material can be coated essentially exclusively, for example, by being sprayed with a highly viscous material, which is cured as rapidly as possible.

The stabilizing material may be applied by means of spraying and/or by dip impregnation.

A foamable stabilizing material may be used so that the weight advantage of shives, for example, can largely be maintained.

A first stabilizing material may be applied in a first step and at least one other stabilizing material in at least one other step.

Sodium silicate, epoxide resin, expandable epoxide resin and/or varnish-like substances can be used as the stabilizing material.

Synthetic and/or biological materials may be used as the stabilizing material.

The stabilizing material may be cured thermally at a temperature between 100° C. and 220° C., preferably between about 120° C. and 200° C. and especially between about 120° C. and 150° C.

In a concrete embodiment, sodium silicate, for example, may be used and is applied to shives by the spray method or by dip impregnation. The sponge-like structure of the shives absorbs the sodium silicate solution because of the high hygroscopicity or by capillary action, the amount metered being determined by the spray method itself or by the residence time in a dip bath.

Alternatively, an expandable epoxy resin may be applied to the shives in similar process steps and expanded and cured in a subsequent heating segment or by supplying other energy. At the same time, the resin penetrates into the pore structures and simultaneously envelops the shives with a protective layer.

Alternatively, or in addition, varnish-like substances or liquid synthetic and/or biological materials with low viscosity, such as lignin or PHP, can be applied, which also result in stabilizing layers.

The stabilizing material can be selected from the point of view that the shives are embedded in a biological base material for producing components, so that there should also be a biological base for the stabilizing material, or from the point of view that the reinforcing material (such as shives) is introduced into a plastic melt, the stabilizing material then being a similar or compatible plastic material. In each case, the stabilizing material should result in increased resistance, so that porous materials, such as shives in particular, are less easily compressed during processing by extrusion, for example, the product also being resistant to temperatures up to about 200° C.

From the point of view of the device, the object of the invention is accomplished in that a second feed station for dumpable or pourable reinforcing material in the form of comminuted shives and/or comminuted woody components of China reed is disposed in the region of the plasticizing and mixing segment.

Downstream from the plasticizing and mixing segment, a mixing device for homogeneously mixing the reinforcing material into the base material can be provided.

A comminuting device for comminuting shives to a size between 0.5mm and 10 mm, preferably 0.5 mm and 5 mm, and further preferably between 0.5 mm and 3 mm, may be present.

An inventive, plastic component, particularly an injection molded component, an extrusion component, or an extrusion blowing component, having a thermoplastic base material and a reinforcing material obtained from plant materials, is distinguished, pursuant to the invention, in that the reinforcing material comprises comminuted shives in dumpable or pourable form, particularly of annual plants such as flax or hemp, and/or similarly comminuted woody components of China reed.

Preferably, shives of “green” starting material (green shives), as explained above, are used. Preferably, the length of the shives is between about 0.5 mm and 10 mm, especially between 0.5 mm and 5 mm and particularly between 0.5 mm and 3 mm.

Preferably, shives of flax and/or hemp and/or kenaf are used.

Additional reinforcing material, such as glass fibers and/or natural fibers, may be contained.

Advisably, the thermoplastic base material consists of thermoplastic plastic and/or of a biological material such as lignin or PHP. These biological materials combine with the shives very well, even without an adhesion-imparting agent. Lignin, in particular, is characterized by good material properties with relation to high strength, impact resistance, and rigidity. Lignin occurs in large amounts as a by-product of cellulose production, and is thereby available inexpensively and in sufficient amounts.

The great advantage of the inventive method lies therein that the reinforcing material can be mixed directly into the flowing melt already while the thermoplastic starting material is being worked up or plasticized and homogenized in the form of a melt, so that an additional, cost-intensive process step is avoided. In this connection, it is a prerequisite only small portions of fiber material, if any, are contained in the shives, so that the pourable or dumpable consistency is maintained. China reed is already a pure, that is fiber-free, product, which only has to be comminuted and in which there is no residual fiber.

Pursuant to the invention, reinforcing material can be mixed into the composition in an injection-molding machine, an extrusion machine, or an extrusion-blowing machine, for example, a second feed device for the dumpable or pourable reinforcing material being provided in the region subsequent to, that is, downstream from, a plasticizing and mixing segment. Because of the dumpable or pourable consistency of the reinforcing material, there is no tendency to form lumps or to become felted, so that direct feed into a melt stream can be metered very well, and the material is absorbed uniformly by the melt, and therefore can be mixed homogeneously. For practical purposes, a part of the plasticizing and/or mixing segment of the extruder should still follow the second feed station, or a subsequent mixing and/or homogenization segment should be arranged, in order to ensure homogeneous mixing.

In addition, if the shives are not already delivered in the required comminuted state, a comminuting device for comminuting the shives to the stated size can be disposed on the device,.

1. A method for producing a reinforced plastic component, particularly by means of injection molding, extrusion, or extrusion blowing, in which a thermoplastic base material is prepared as a melt and a reinforcing material obtained from plant materials is introduced, wherein comminuted shives, in a dumpable and pourable form, particularly of annual plants, and/or similarly comminuted woody components of China reed are passed to the melt of the base material as a reinforcing material, and homogeneously mixed into it, the reinforcing material not containing any portions of fiber material, or any portions that significantly impair the dumpability or pourability.

2. The method of claim 1, wherein shives of green starting material are used.

3. The method of claims 1 or 2, wherein the length of the shives is between about 0.5 mm and 10 mm, preferably between 0.5 mm and 5 mm and particularly between 0.5 mm and 3 mm.

4. The method of one of the preceding claims, wherein shives of flax and/or hemp and/or kenaf are used.

5. The method of one of the preceding claims, wherein additional reinforcing materials, such as fiberglass and/or natural fibers, are used.

6. The method of one of the preceding claims, wherein compatibility-producing agents and/or adhesion-imparting agents are used, particularly in an amount of 0.5 to 3%.

7. The method of one of the preceding claims, wherein a thermoplastic plastic and/or a biological material, such as lignin or PHP, is used as the thermoplastic base material.

8. The method of one of the preceding claims, wherein, before the reinforcing material in the form of comminuted shives or comminuted woody components of China reed are mixed in, a stabilizing material is introduced into the pores of the reinforcing material and/or the reinforcing material is encased in stabilizing material, so that the reinforcing material has a greater resistance to compression.

9. The method of claim 8, wherein pores and cavities of the reinforcing material are filled with the stabilizing material to the greatest possible extent.

10. The method of claim 8 or 9, wherein the reinforcing material is encased essentially exclusively.

11. The method of one of claims 8 to 10, wherein the stabilizing material is applied by spraying and/or by dip impregnation.

12. The method of one of claims 8 to 11, wherein a foamable stabilizing material, particularly epoxy resin, is used.

13. The method of one of claims 8 to 12, wherein a first stabilizing material is applied, in a first step and at least one other stabilizing material is applied in at least one other step.

14. The method of one of claims 8 to 13, wherein sodium silicate, epoxy resin, expandable epoxy resin and/or varnish-like substances are used as the stabilizing material.

15. The method of one of claims 8 to 14, wherein synthetic and/or biological materials are used as the stabilizing material.

16. The method of one of claims 8 to 15, wherein the stabilizing material is cured thermally at a temperature between 100° C. and 220° C., preferably between about 120° C. and 200° C. and particularly between about 120° C. and 150° C.

17. A device for producing a reinforced plastic component, particularly for implementing the method of one of the preceding claims, having a feed station for feeding in thermoplastic material that is to be treated, and a plasticizing and mixing segment for the plasticizing and homogenizing the base material, wherein a second feed station for dumpable or pourable reinforcing material in the form of comminuted shives and/or comminuted woody components of China reed is arranged in the region of the plasticizing and mixing segment.

18. The device of claim 17, wherein a mixing device for homogeneously mixing the reinforcing material into the base material is disposed downstream from the plasticizing and mixing segment.

19. The device of claim 17 or 18, characterized by a comminution device for comminution of shives to a size between 0.5 mm and 10 mm, preferably between 0.5 mm and 5 mm, and further preferably between 0.5 mm and 3 mm.

20. A reinforced plastic component, particularly a component produced by injection molding, extrusion, or extrusion blowing, having a thermoplastic base material and a reinforcing material obtained from plant materials, wherein the reinforcing material comprises comminuted shives in dumpable or pourable form, particularly of annual plants such as flax or hemp, and/or similarly comminuted woody components of China reed.

21. The reinforced plastic component of claim 20, characterized by shives of green starting material.

22. The reinforced plastic component of claim 20 or 21, wherein the shives have a length of 0.5 mm to 10 mm, preferably between about 0.5 mm and 5 mm and particularly of about 0.5 mm to 3 mm.

23. The reinforced plastic component of one of claims 20 to 22, characterized by additional reinforcing material, such as glass fibers and/or natural fibers.

24. The reinforced plastic component of one of claims 20 to 23, wherein the thermoplastic base material consists of thermoplastic plastic and/or a biological material such as lignin or PHP.

25. The reinforced plastic component of one of claims 20 to 24, wherein the reinforcing material is filled and/or mantled with a stabilizing material in advance, that is, before it is mixed into the base material.
